(19) United States
(12) Patent Application Publication
(10) Pub. No.: US 2022/0106046 A1
(43) Pub. Date: Apr. 7, 2022

(54) PRESSURE CONTAINMENT COMPONENT FOR AIRCRAFT SYSTEMS

(71) Applicant: Honeywell International Inc., Charlotte, NC (US)

(72) Inventors: Abraham Valenzuela, Mexicali (MX); Rodolfo Fernandez, Mexicali (MX); Ellis Craddock, Torrance, CA (US)

(21) Appl. No.: 17/064,456

(22) Filed: Oct. 6, 2020

(51) Int. Cl. B64D 13/02; B64D 13/08; C08K 7/06; C08L 71/00; C08K 3/04

(52) U.S. Cl. CPC B64D 13/02; B64D 13/08; B64D 2013/0618; C08L 71/00; C08K 3/04; C08K 7/06

(57) ABSTRACT

The disclosure describes a pressure containment component of a pressurized system of an aircraft. The pressure containment component includes a dimensionally complex monolithic body defining an inlet and an outlet. The monolithic body includes a polyether ether ketone (PEEK) matrix and carbon fibers distributed throughout the PEEK matrix. The monolithic body is configured to contain a pressure greater than or equal to about 20 kPa from the pressurized system. The disclosure also describes a method of forming a pressure containment component of a pressurized system of an aircraft. The method includes injecting a thermoplastic mixture into a mold for a monolithic body of the component. The thermoplastic mixture includes a molten PEEK and carbon fibers distributed throughout the molten PEEK. The method includes cooling the thermoplastic mixture to form the monolithic body.

### TECHNICAL FIELD

The present disclosure relates to pressure containment components and techniques for fabricating pressure containment components.

### BACKGROUND

Pressure containment components, such as plenums, ducts, and duct transitions, may be used to direct air into or out of a pressurized component, such as a compressor or pump. Pressure containment components used in aircraft applications may be manufactured using metal forming methods, such as metal casting or sheet forming, or composite bonding methods, such as hand lay-up forming.

### SUMMARY

In general, the disclosure describes fabrication of pressure containment components from relatively lightweight materials using relatively inexpensive injection molding processes. Pressure containment components described herein include a monolithic body formed from a lightweight composite of carbon fibers distributed throughout a polyether ether ketone (PEEK) matrix. This lightweight composite may be sufficiently strong, heat resistant, and fatigue resistant to withstand operating pressures (e.g., greater than or equal to about 20 kPa operating pressure relative to atmosphere), elevated temperatures (e.g., greater than or equal to about 80° C. operating temperature), and high duty cycles (e.g., greater than or equal to about 40,000 operating cycles) experienced by various aircraft systems, such as environmental control systems. The monolithic body may have a relatively large or dimensionally complex form that may be relatively expensive to fabricate using lay-up forming or metal casting processes, but relatively inexpensive to fabricate using injection molding. In this way, the pressure containment components fabricated from techniques described herein may be inexpensive and lightweight for use in a variety of pressurized aircraft systems.

In some examples, the disclosure describes a pressure containment component of a pressurized system of an aircraft. The pressure containment component includes a dimensionally complex monolithic body including an inlet and an outlet defining an axis of the monolithic body. The monolithic body includes a polyether ether ketone (PEEK) matrix and carbon fibers distributed throughout the PEEK matrix. The monolithic body is configured to contain a pressure greater than or equal to about 20 kPa from the pressurized system.

In some examples, the disclosure describes a system of an aircraft. The system includes a vapor cycle refrigeration unit (VCRU) configured to cool pressurized bleed air from one or more engines of the aircraft using ram air. The VCRU includes at least one pressurized component configured to operate at a pressure greater than or equal to about 20 kPa. The at least one pressurized component includes a pressure containment component that includes a dimensionally complex monolithic body including an inlet and an outlet defining an axis of the monolithic body. The monolithic body includes a polyether ether ketone (PEEK) matrix and carbon fibers distributed throughout the PEEK matrix.

In some examples, the disclosure describes a method of forming a pressure containment component of a pressurized system of an aircraft. The method includes injecting a thermoplastic mixture into a mold for a monolithic body of the pressure containment component. The thermoplastic mixture includes molten polyether ether ketone (PEEK) and carbon fibers in the molten PEEK. The method further includes cooling the thermoplastic mixture to form the monolithic body of the component, wherein the monolithic body includes an inlet and an outlet defining an axis of the monolithic body.

The details of one or more examples are set forth in the accompanying drawings and the description below. Other features, objects, and advantages will be apparent from the description and drawings, and from the claims.

### BRIEF DESCRIPTION OF THE FIGURES

The details of one or more examples are set forth in the accompanying drawings and the description below. Other features, objects, and advantages will be apparent from the description and drawings, and from the claims.

FIG. 1A is a conceptual and schematic diagram illustrating an example vapor cycle refrigeration unit (VCRU) of an aircraft that includes one or more pressure containment components.

FIG. 1B is a conceptual and schematic diagram illustrating an example condenser of the VCRU of FIG. 1A that includes one or more pressure containment components.

FIG. 1C is a perspective view diagram illustrating an example condenser outlet plenum of the condenser of FIG. 1B.

FIG. 1D is a front elevation view diagram illustrating the example condenser outlet plenum of the condenser of FIG. 1B.

FIG. 1E is a top elevation view diagram illustrating the example condenser outlet plenum of the condenser of FIG. 1B.

FIG. 1F is a side elevation view diagram illustrating the example condenser outlet plenum of the condenser of FIG. 1B.

FIG. 2A is a conceptual and schematic diagram illustrating an example system for fabricating a pressure containment component.

FIG. 2B is a flowchart of an example technique for fabricating a pressure containment component.

### DETAILED DESCRIPTION

In general, the disclosure describes fabrication of pressure containment components from relatively lightweight composite materials using relatively inexpensive injection molding processes. Metal forming and composite bonding methods may require a relatively large lead time to manufacture, and may result in components that are relatively heavy, expensive, or both. Pressure containment components may include any component of or coupled to a pressurized component that is configured to contain and/or direct pressurized air, such as a duct between pressurized components or a plenum of a pressurized component. These pressure containment components may be used in a variety of air systems that experience operating pressures (e.g., up to about 40 kPa relative to atmosphere, such as about 20 kPa operating pressure), elevated temperatures (e.g., up to about 140° C., such as about 80° C. operating temperature), and relatively high duty cycles (e.g., up to about 40,000 cycles, such as 10,000 operating cycles) including, but not limited to ventilation systems, environmental control systems, ram air systems, and the like. The pressure containment components may be used in air systems in a variety of applications including, but not limited to, aircraft, watercraft, spacecraft, and the like, including other vehicles.

In some examples, components described herein may be used in pressurized air systems on an aircraft. An aircraft may include various pressurized air systems configured to control properties of air, such as flow rate, pressure, temperature, and humidity, for temperature control of propulsion and accessory components and environmental control of a contained volume, such as a passenger cabin. These pressurized air systems may generate and maintain air at relatively moderate temperature, pressure, and flow conditions, may be particularly sensitive to weight and operational continuity of components of the pressurized air systems, and may include various contaminants that could react with equipment in the pressurized air systems. As such, pressure containment components fabricated from relatively lightweight composite materials described herein may be particularly useful for weight- and/or performance-sensitive pressurized systems of aircraft.

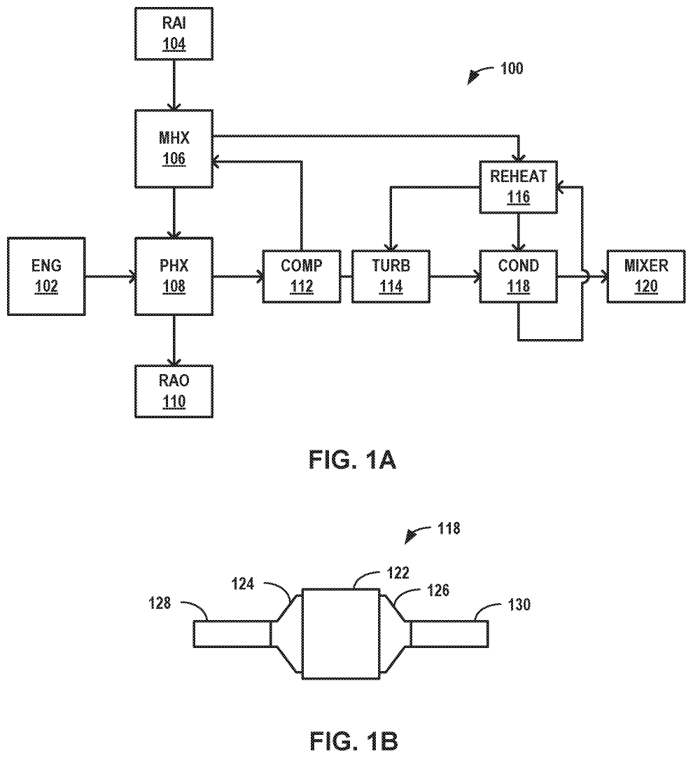

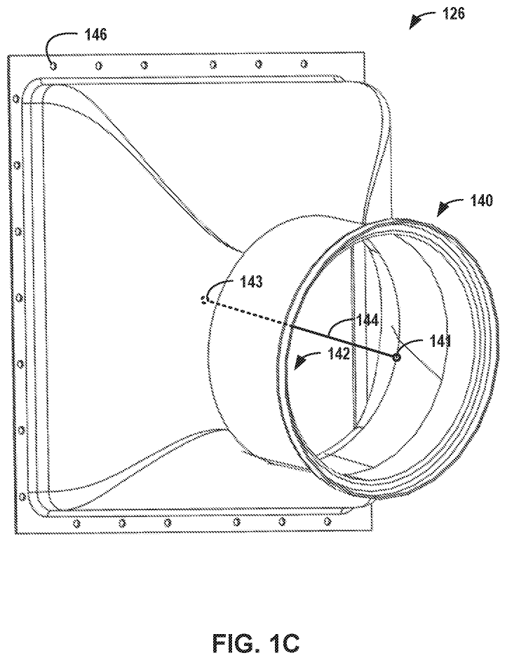

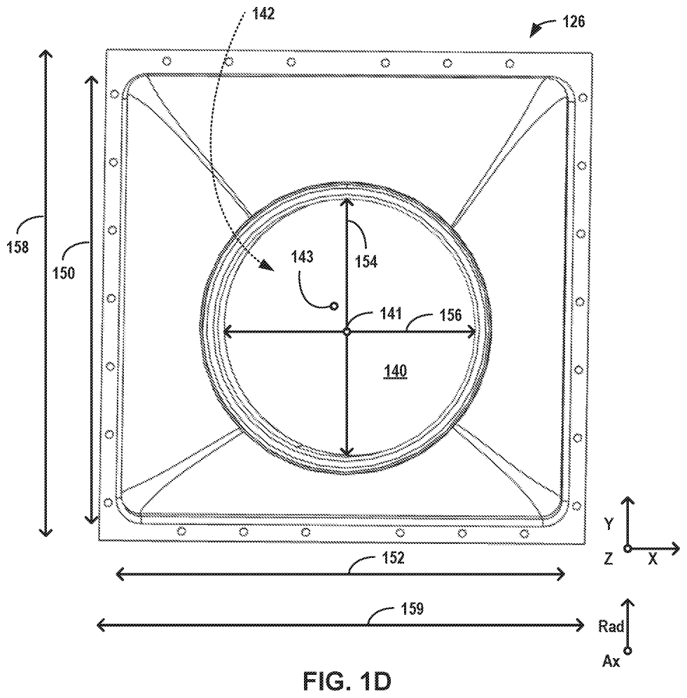

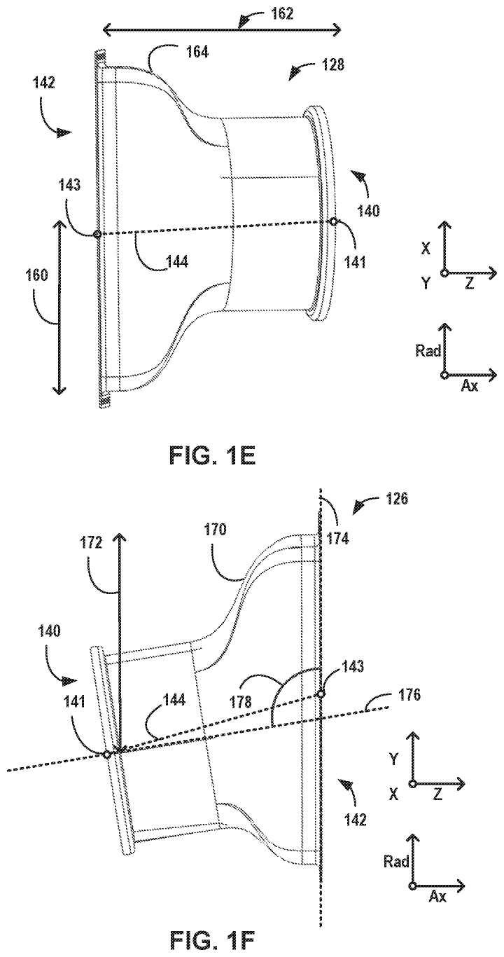

As one example of such weight- and/or performance-sensitive systems, FIG. 1A is a block diagram of an example vapor cycle refrigeration unit (VCRU) 100 of an aircraft, in accordance with examples described herein. As will be described below, VCRU 100 includes various pressurized systems and pressurized components, such as a ram air circuit, a vapor cycle circuit, and a subcooling circuit, that may include pressure containment components described herein. However, other pressurized systems and pressurized components of aircraft may also include pressure containment components, such as air recirculation systems, outflow systems, and the like.

In the example of FIG. 1A, VCRU 100 is configured to cool pressurized bleed air from one or more engines using ram air. VCRU 100 is configured to receive ram air from outside the aircraft through ram air inlet (RAI) 104, flow the ram air across a main heat exchanger (MHX) 106 and a primary heat exchanger (PHX) 108, and discharge the ram air through a ram air outlet 110. VCRU 100 is also configured to receive pressurized bleed air from an aircraft engine 102 and cool the bleed air at primary heat exchanger 108 using the ram air. VCRU 100 is configured to pressurize the cooled bleed air with compressor (COMP) 112 and further cools the bleed air with main heat exchanger 106 using the ram air. VCRU 100 is configured to further cool the bleed air with a reheater (REHEAT) 116 and remove water from the bleed air with a condenser (COND) 118 using cooled air from a turbine (TURB) 114. VCRU 100 is configured to heat the dried bleed air with reheater 116 and expands the dried air with turbine 114 to generate power for compressor 112. VCRU 100 is configured to discharge the reduced pressure bleed air through condenser 118 to a mixer (MIXER) 120 for use in an aircraft ventilation system.

Various pressure containment components of VCRU 100 may be configured to contain (e.g., direct and/or limit flow of) air at relatively moderate conditions (e.g., pressures greater than or equal to about 20 kPa and less than or equal to about 70 kPa, and temperatures in a range of about 80° C. to about 150° C.) that may include one or more reactive or condensable contaminants, such as hydrocarbons. For example, while components upstream of turbine 114 may be subject to relatively high pressures and components upstream of main heat exchanger 106 may be subject to relatively high temperatures, components downstream of turbine 114 and main heat exchanger 106, such as condenser 118, may be subject to relatively lower pressures and temperatures. While these relatively moderate conditions may be substantially lower than the higher upstream temperature or pressure conditions, they may still exert stresses on the pressure containment components.

In some examples, components of VCRU 100 may be subject to fluctuating conditions, such as a range of temperatures, a range of pressures, or a high number and/or frequency of duty cycles (e.g., increase or decrease of pressure or start or stop of operation). For example, VCRU 100 may operate differently based on conditions inside and/or outside the aircraft, such as a temperature of ram air, an occupancy of a cabin supplied by the ventilation system, and the like. These fluctuating conditions may cause stresses on pressure containment components of VCRU 100 due to thermally-induced expansion or contraction or pressure-induced forces or vibrations.

In some examples, pressure containment components of VCRU 100 may be relatively large and/or dimensionally complex. As one example, pressurized components that utilize an air stream, such as a ram air circuit, as a heat sink may receive relatively high flow rates from the air stream, such that pressure containment components directing air into or out of heat exchangers that utilize the air stream may be relatively large. As another example, components that direct air from one component or conduit to another component or conduit may include asymmetrical shapes that change a direction or velocity of the air.

Pressure containment components having sufficient mechanical and thermal properties to withstand operating conditions of various pressurized air systems in aircraft may be fabricated from bonded sheets of material, such as fiberglass. However, such materials may be expensive and/or difficult to fabricate into relatively large and/or dimensionally complex components. For example, in composite lay-up forming, fiberglass sheets may be preformed into specific shapes, placed into a mold, impregnated using epoxy, and compressed, resulting in non-monolithic forms that may be relatively inconsistent from part to part.

According to examples described herein, pressure containment components of pressurized systems, such as VCRU 100 of FIG. 1A, may be fabricated as a monolithic body from a relatively lightweight composite. For example, pressurized components fabricated using metal forming methods, such as casting, may be relatively heavy, as such components may include aluminum (e.g., density of about 2.7 g/cm³), steel (e.g., density of about 8 g/cm³), and other metals configured to withstand relatively high temperatures and pressures.

A monolithic body may include a body formed as a substantially unitary structure (e.g., unitary or nearly unitary). For example, the monolithic body may have a substantially (e.g., greater than 99%) continuous microstructure, such as a semicrystalline microstructure extending through the monolithic body. As will be described below, the monolithic body is formed through injection molding. A manufacturing cost of pressure containment components formed by injection molding may be relatively independent of a size or dimensional complexity of the pressure containment component compared to pressure containment components formed from non-unitary structures, such as bonded fiberglass or metal sheets.

The monolithic body includes a polyether ether ketone (PEEK) matrix. PEEK is a semicrystalline thermoplastic polymer having a relatively high melting point, such as about 343° C., and a relatively high glass transition temperature, such as about 143° C. As a result of this relatively high melting point and/or relatively high glass transition temperature, PEEK may be dimensionally stable at temperatures experienced in a variety of pressurized systems. For example, the monolithic body may be configured to contain air at a temperature less than the glass transition temperature of PEEK, such as up to about 80° C., such that the monolithic body may be substantially dimensionally stable across an operating envelope of various components of VCRU 100, such as condenser 118.

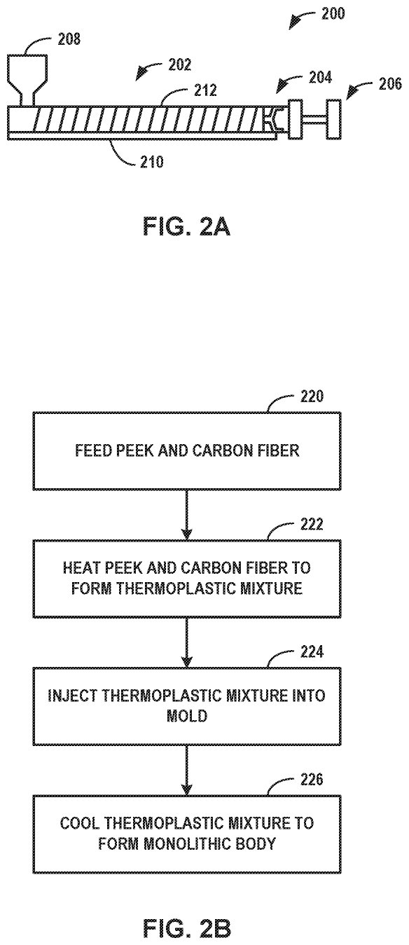

Upon cooling, molten PEEK may form a lightweight (e.g., density of about 1.3 g/cm³) semicrystalline PEEK matrix. For example, as will be described in FIGS. 2A and 2B below, PEEK may be heated above its melting point, injected into a mold in molten form, and cooled to form a pressure containment component having a monolithic body that substantially corresponds to the mold. During cooling, the PEEK matrix may remain relatively dimensionally stable, such that the resulting monolithic body substantially conforms to the mold during cooling. For example, PEEK may have a relatively low coefficient of thermal expansion such that, upon cooling, the monolithic body may not substantially deform from the molded shape.

PEEK may be relatively unreactive with and have a high resistance to contaminants encountered in various pressurized air system of an aircraft. For example, PEEK may exhibit excellent resistance to hydraulic fluids, lubricating oils, fuels, cleaning agents, de-icing fluids, and other fluids that may become entrained or mixed with air in the various pressurized air systems.

To further strengthen, stiffen, and thermally stabilize the component, the monolithic body includes carbon fibers distributed throughout the PEEK matrix to define a carbon fiber reinforced PEEK. Carbon fibers may include a substantially one-dimensional form (e.g., rods) having an average diameter between about 1 micrometer and about 50 micrometers; however, other forms of carbon may be used. Carbon fibers may be present in the PEEK matrix at a concentration sufficient to provide the PEEK matrix with elevated tensile strength and stiffness and reduced coefficient of thermal expansion. Carbon fibers may be present in the PEEK matrix of the monolithic body at a concentration of about 20 wt. % to about 40 wt. %, such as about 30 wt. %.

Carbon fiber reinforced PEEK may include improved mechanical properties compared to PEEK. As one example, PEEK having about 30 wt. % carbon fiber may include the following properties at room temperature (˜23° C.), as shown in Table 1 below:

TABLE 1

| Tensile Strength | 265 | MPa |
|---|---|---|
| Tensile Elongation | 1.7% | |
| Tensile Modulus | 28 | GPa |
| Flexural Strength | 380 | MPa |
| Flexural Modulus | 24 | GPa |
| Compressive Strength | 320 | MPa |

A monolithic body fabricated from carbon fiber reinforced PEEK may have high strength and stiffness to contain relatively moderate pressures from a pressurized system. For example, a monolithic body may be configured to contain a pressure up to about 20 kPa under ordinary operating conditions and up to about 40 kPa under exceptional conditions.

Carbon fiber reinforced PEEK may have improved thermal properties compared to PEEK. As one example, PEEK having about 30 wt. % carbon fiber may include the following thermal properties, as shown in Table 2 below:

TABLE 2

| Glass Transition Temperature (T_{g}) | 143° C. |
|---|---|
| CTE (along flow below T_{g}) | 5 ppm/° C. |
| Mold Shrinkage (along flow) | 0.1% |

A monolithic body fabricated from carbon fiber reinforced PEEK may have a high dimensional stability across temperatures experienced during injection molding. For example, during formation of the monolithic body, molten PEEK of the monolithic body may cool from above a melting point of PEEK, such as 343° C., to a handling temperature, such as about 23° C. Across this range, the monolithic body may experience relatively little contraction, such that the monolithic body may have a shape that substantially conforms to a volume of a corresponding mold. During operation, the monolithic body may undergo relatively little expansion for conditions experience in various pressurized air systems, such as up to 120° C., resulting in low thermally-induced stresses. For example, various components of VCRU 100 may include aluminum, having a CTE of about 23 ppm/° C., such that a differential in thermal expansion between the carbon fiber reinforced PEEK and the pressurized component may be relatively small.

Pressure containment components may include other components in addition to a monolithic body. In some examples, pressure containment components may include one or more pressure sealing components for sealing surfaces of the pressure containment components against other components. Pressure sealing components may include, but are not limited to, gaskets, adhesives, and the like. In some examples, each of an inlet and an outlet of the monolithic body is coupled to a sealing component. As explained above, pressure containment components fabricated from carbon fiber reinforced PEEK may have high dimensional stability, such that stresses exerted on the pressure sealing components from expansion or contraction of the monolithic body may be small.

Pressure containment components formed from the carbon fiber reinforced PEEK matrix described above may be used as or with a variety of pressurized components within a pressurized system. In some examples, pressure containment components may include one or more conduits between pressurized systems. For example, pressure containment components may include, but are not limited to, piping, ducting, cavities, plenums, or other contained volumes used in pressurized systems. In systems that are relatively space-constrained environments, such as aircraft, pressure containment components may include relatively complex shapes, such that these space-constrained systems may have a relatively compact form and/or low weight compared to systems without such space constraints.

In some examples, one or more pressure containment components may be incorporated into a pressurized component. For example, pressurized components may include pressure containment components, such as plenums, to direct air into or out of one or more volumes or passages within the pressurized component or direct air through the pressurized component. As one example, FIG. 1B is a conceptual and schematic diagram illustrating the example condenser 118 of VCRU 100 of FIG. 1A, where condenser 118 includes one or more pressure containment components fabricated from a lightweight composite that includes injection molded, carbon fiber reinforced PEEK. Condenser 118 includes a condenser body 122, an inlet plenum 124, and an outlet plenum 126. Inlet plenum 124 may be coupled to an inlet duct 128 and configured to receive air from turbine 114 (FIG. 1A). Outlet plenum 126 may be coupled to an outlet duct 130 and configured to discharge air to mixer 120 (FIG. 1A) for distribution into a cabin ventilation system and/or mixed with recirculated air.

Conditions of air received and discharged by inlet plenum 124 and outlet plenum 126, respectively, may be dependent on conditions of various other systems within or coupled to VCRU 100, such as a temperature of ram air, a pressure of bleed air (or air from an auxiliary power unit or cabin air compressor, if grounded), a temperature or pressure of air in a cabin downstream of mixer 120, or a flow rate of recirculated air, such that inlet plenum 124 and/or outlet plenum 126 may receive air at a range of temperatures and pressures. For example, while not shown in FIG. 1A, mixer 120 may receive recirculated air from the cabin, such that air discharged into mixer 120 from outlet plenum 126 may be relatively cold and pressurized to make up for air discharged through outflow valves and/or warmed through components or occupants of the cabin. Further, a temperature of an outer surface of condenser 118 may be elevated compared to a temperature of air received or discharged by inlet plenum 124 and outlet plenum 126. For example, while not shown in FIG. 1A, condenser 118 may be integrated with reheater 116, which may a hot bleed air stream prior to expansion through turbine 114. As such, inlet plenum 124 and outlet plenum 126, and other pressure containment components of VCRU 100, may be configured for conditions with moderately high pressures and temperatures, and which undergo a variety of flow conditions.

In addition to operating as a pressure containment component, inlet plenum 124 and outlet plenum 126 may each operate as a pressure transition component. A pressure transition component may include tapering that accommodates a dimensional change, such as for connecting a round duct to a squared flange (HX) of condenser body 122. For example, condenser body 122 may be configured with an increased surface area for heat exchange, including a relatively large volume, such that a cross-section of condenser body 122 may be greater than each of inlet duct 128 and outlet duct 130. As a result of this change in cross-section and resulting change in pressure, inlet plenum 124 and outlet plenum 126 may experience various stresses. A geometric features of a pressure transition component, such as curves or vertices, may be configured to have a reduced aerodynamic impact for the geometry change, and my not be configured for an improved thermal expansion profile (e.g., to reduce thermal expansion stresses according to a geometry).

Pressure containment components, such as outlet plenum 126, are fabricated through injection molding. Injection molding permits fabrication of a pressure containment component having a relatively dimensionally complex monolithic body compared to pressure containment components fabricated from sheets of materials, such as fiberglass, through lay-up forming. Injection molding also permits fabrication of a pressure containment component from a relatively lightweight composite compared to pressure containment components fabricated from metals through casting.

Dimensional complexity of the monolithic body may be represented by a variety of measures of geometric complexity including, but not limited to, an algebraic complexity (e.g., a measure of a degree of polynomials for representing the monolithic body), a morphological complexity (e.g., a measure of local surface variation), a combinatorial complexity (e.g., a measure of vertexes in polygonal meshes representing the monolithic body), and the like.

As an example of a pressure containment component that includes a dimensionally complex monolithic body, FIG. 1C is a perspective view diagram illustrating an example condenser outlet plenum 126 of the condenser 118 of FIG. 1B. Outlet plenum 126 includes an inlet 142 configured to couple to condenser 118 and an outlet 140 configured to couple to ducting of a ventilation system. Outlet plenum 126 may include a plurality of holes 146 for securing outlet plenum 126 to condenser 118. Outlet plenum 126 may include an axis 144 from a center 143 of inlet 142 to a center 141 of outlet 140. Axis 144 may represent a general axis of flow of air through outlet plenum 126.

In some examples, a dimensionally complex monolithic body may be a monolithic body that is functionally complex to manufacture from in situ material formation (e.g., requiring a high number or complexity of operations), such as composite lay-up forming. For example, a round or square cylinder may be relatively simple to manufacture from a planar sheet, the former involving bending a sheet around an axis and the latter involving bending or bonding sheets along vertices around an axis. As illustrated in the example of FIG. 1C, outlet plenum 126 may involve a high number and/or complexity of operations to form from impregnated sheets, such as involving bending sheets along multiple axes, aligning or placing the sheets along multiple planes, and compressing the various sheets together. In contrast, a dimensionally complex monolithic body formed from injection molding may involve a relatively and/or inexpensive simple process that produces a dimensionally complex monolithic body.

In some examples, a dimensionally complex monolithic body may be a monolithic body that includes at least one of radial or axial asymmetry. In the example of FIG. 1C, axial asymmetry may include reflectional asymmetry along axis 144, while radial asymmetry may include asymmetry across axis 144. For example, a round cylinder duct may have radial and axial symmetry, as the cylinder duct has a constant radius around and along a central axis. As illustrated in FIG. 1C, outlet plenum 126 is not rotationally symmetrical along axis 144 or reflectionally symmetrical across axis 144. For example, as will be described further in FIGS. 1D-1F below, various surfaces of outlet plenum 126 may be at a variety of distances from axis 144 based on a position along (e.g., axial) or around (e.g., radial) axis 144. Such asymmetry may be relatively difficult to form from lay-up forming methods. In contrast, a dimensionally complex monolithic body formed from injection molding may involve relatively simple process that may have a low lead time (e.g., for design and fabrication of platens for a single mold).

In some examples, a dimensionally complex monolithic body may include a monolithic body that is not reflectionally symmetrical across an axis of the monolithic body. FIG. 1D is a front elevation view diagram illustrating the example condenser outlet plenum 126 of the condenser 118 of FIG. 1B. Inlet 142 of outlet plenum 126 has a height 150 in a y-direction and a width 152 in an x-direction (orthogonal x-y-z axes are shown in the figures for ease of description), while outlet 140 of outlet plenum 126 has a height 154 in a y-direction and a width 156 an x-direction. In some examples, a dimensionally complex monolithic body may include a pressure transition duct in which the inlet and the outlet have different diameters. For example, height 150 of inlet 142 is greater than height 154 of outlet 140, and width 152 of inlet 142 is greater than width 156 of outlet 140. Outlet plenum 126 has a maximum height 158 in an x-direction, a maximum width 159 in a y-direction (collectively, maximum diameters), and a maximum depth 162 (shown in FIG. 1E) in a z-direction. In some examples, pressure containment components described herein may include relatively large dimensions. For example, maximum height 158, maximum width 159, and maximum depth 162 may each be greater than or equal to about 25 centimeters.

In some examples, a dimensionally complex monolithic body may include a monolithic body that is not rotationally symmetrical along an axis of the monolithic body. FIG. 1E is a top elevation view diagram illustrating the example condenser outlet plenum 126 of the condenser 118 of FIG. 1B, while FIG. 1F is a side elevation view diagram illustrating the example condenser outlet plenum 126 of the condenser 118 of FIG. 1B. Referring to FIG. 1E, center 141 of outlet 140 along an x-axis is offset 160 from an outer edge of inlet 142. Outlet plenum 126 includes different cross-sectional shapes along axis 144. For example, inlet 142 has a substantially square shape (e.g., square or nearly square to the extent permitted by manufacturing tolerances), while outlet 140 has a substantially round cross-sectional shape (e.g., round, such as circular, or nearly round to the extent permitted by manufacturing tolerances) across axis 144. Center 143 of inlet 142 and center 141 of outlet 140 are not aligned, such that axis 144 forms an angle with a plane of inlet 142.

In some examples, a dimensionally complex monolithic body may be a monolithic body that includes at least some axial curvature. For example, the monolithic body may include one or more curved surfaces having an axis of curvature that is not parallel to the axis of the monolithic body. A round cylinder or conical duct may have radial curvature rather than axial curvature, as the round cylinder or conical duct has curvature that is parallel to an axis of the duct. In contrast, axial curvature may include curvature relative to axis 144. For example, as illustrated in FIG. 1C and illustrated more fully in FIGS. 1E and 1F, various lateral surfaces 164 (in FIG. 1E) and 170 (in FIG. 1F) of outlet plenum 126 curve from inlet 142 to outlet 140 in a non-linear fashion. Such curvature may be relatively difficult to form from lay-up forming methods. For example, in lay-up forming, multiple sheets may each be curved into a mold and compressed to form a part at relatively a low fabrication yield. The one or more curved surfaces may define at least 25% of a surface area of the monolithic body.

FIG. 2A is a conceptual and schematic diagram illustrating an example injection molding system 200 for fabricating a pressure containment component. Injection molding system 200 includes an injection unit 202, a mold assembly 204, and a clamping unit 206.

Injection unit 202 may be configured to inject a thermoplastic mixture, including molten polyether ether ketone (PEEK) and carbon fibers distributed throughout the molten PEEK, into mold assembly 204. For example, injection unit 202 may include a hopper 208, one or more heaters 210, and a feed assembly 212. Hopper 208 may be configured to feed raw materials, such as PEEK and carbon fiber, into feed assembly 212. For example, PEEK may be present in the form of PEEK pellets and the carbon fibers may be present in the form of carbon fiber powder; however, in other examples, both PEEK and carbon fibers may be incorporated into a same feedstock. Feed assembly 212 may be configured to receive the PEEK and carbon fibers from hopper 208 and advance the PEEK and carbon fibers to an injection nozzle. Each heater 210 may be configured to heat the PEEK pellets above a melting point of PEEK (e.g., 345° C.).

Mold assembly 204 may include one or more molds configured to receive the thermoplastic mixture and cool the thermoplastic mixture to form the monolithic body of the component. The one or more molds of mold assembly 204 may substantially correspond to a shape of a pressure containment component, such that post-processing of a component formed from in the one or more molds may be reduced or eliminated. In some examples, mold assembly 204 may include active cooling components, while in other examples, mold assembly 204 may permit air-cooling of the mold.

FIG. 2B is a flowchart of an example technique for fabricating a pressure containment component. While the technique is described with reference to injection molding system 200 of FIG. 2A, in other examples, the technique can be performed using another molding system.

The method of FIG. 2B includes feeding polyether ether ketone (PEEK) and carbon fibers (220). PEEK and carbon fibers may be stored and/or fed in a variety of forms including, but not limited to, powders, pellets, and the like. For example, the PEEK may be in the form of PEEK pellets and the carbons fibers may be in the form of carbon fiber powder. In some examples, PEEK and carbon fibers may be present in a premixed form, such as a PEEK and carbon fiber pellet. A weight or volume ratio of PEEK and carbon fibers may correspond to a composition of the composite monolithic body, such as about 60 wt. % to about 80 wt. % PEEK and about 20 wt. % to about 40 wt. % carbon fiber. In some examples, the PEEK and carbon fibers may be preheated prior to being fed into feed assembly 212, such as in hopper 208. For example, PEEK and carbon fibers may be heated to between about 40° C. and about 100° C.

The method includes heating PEEK and carbon fiber to form a thermoplastic mixture of molten PEEK and carbon fibers distributed throughout the molten PEEK (222). For example, heaters 210 may heat the PEEK pellets above the melting temperature to melt the pellets into molten PEEK, such as above about 345° C. The carbon fibers may be relatively distributed throughout the molten PEEK. For example, feed assembly 212 may mix the molten PEEK with the carbon fibers while advancing the thermoplastic mixture to mold assembly 204.

The method includes injecting the thermoplastic mixture into a mold assembly that includes a mold for a monolithic body of the component (224). For example, feed assembly 212 may exert a pressure on the feedstock to inject molten PEEK and carbon fibers into mold assembly 204 and maintain the pressure during cooling to at least partially account for contraction of the thermoplastic mixture during cooling. The mold may correspond to the form of the monolithic body, such that the mold may have a dimensionally complex shape.

The method includes cooling the thermoplastic mixture to form the monolithic body of the component (226). For example, heaters 210 may continue to heat the thermoplastic mixture to achieve a particular cooling rate, such that various cooling-related defects may be reduced.

In some examples, such as when used to describe numerical values, “about” or “approximately” used herein refers to a range within the numerical value resulting from manufacturing tolerances and/or within 1%, 5%, or 10% of the numerical value. For example, a length of about 10 mm refers to a length of 10 mm to the extent permitted by manufacturing tolerances, or a length of 10 mm +/−0.1 mm, +/−0.5 mm, or +/−1 mm in various examples.

Example 1: A pressure containment component of a pressurized system of an aircraft, the pressure containment component that includes a dimensionally complex monolithic body including an inlet and an outlet defining an axis of the monolithic body, the monolithic body that includes a polyether ether ketone (PEEK) matrix; and carbon fibers distributed throughout the PEEK matrix, wherein the monolithic body is configured to contain a pressure greater than or equal to about 20 kPa from the pressurized system.

Example 2: The pressure containment component of example 1, wherein the monolithic body defines a maximum length along the axis and a maximum diameter perpendicular to the axis, and wherein each of the maximum length and the maximum diameter are greater than or equal to about 25 centimeters.

Example 3: The pressure containment component of example 1 or 2, wherein the monolithic body is not rotationally symmetrical along the axis or reflectionally symmetrical across the axis.

Example 4: The pressure containment component of any of examples 1 to 3, wherein the monolithic body comprises a pressure transition duct, and wherein the inlet and the outlet have different diameters.

Example 5: The pressure containment component of any of examples 1 to 4, wherein the monolithic body comprises a substantially continuous microstructure.

Example 6: The pressure containment component of any of examples 1 to 5, wherein the carbon fibers are present in the PEEK matrix at a concentration of about 20 wt. % to about 40 wt. %.

Example 7: The pressure containment component of any of examples 1 to 6, wherein the pressurized systems comprises a vapor cycle refrigeration unit of the aircraft.

Example 8: The pressure containment component of example 7, wherein the pressurized system includes a condenser, and wherein the monolithic body comprises an outlet plenum configured to couple to the condenser and discharge pressurized air from the condenser.

Example 9: A system of an aircraft that includes a vapor cycle refrigeration unit (VCRU) configured to cool pressurized bleed air from one or more engines of the aircraft using ram air, the VCRU comprising at least one pressurized component configured to operate at a pressure greater than or equal to about 20 kPa, the at least one pressurized component comprising a pressure containment component that includes a dimensionally complex monolithic body including an inlet and an outlet defining an axis of the monolithic body, the monolithic body that includes a polyether ether ketone (PEEK) matrix; and carbon fibers distributed throughout the PEEK matrix.

Example 10: The system of example 9, wherein the at least one pressurized component is configured to operate at a temperature greater than or equal to about 80° C.

Example 11: The system of example 9 or 10, wherein the at least one pressurized component comprises a condenser, and wherein the monolithic body comprises an outlet plenum configured to couple to the condenser and discharge pressurized air from the condenser.

Example 12: A method of forming a pressure containment component of a pressurized system of an aircraft that includes injecting a thermoplastic mixture into a mold for a monolithic body of the pressure containment component, the thermoplastic mixture that includes molten polyether ether ketone (PEEK); and carbon fibers in the molten PEEK; and cooling the thermoplastic mixture to form the monolithic body of the component, wherein the monolithic body includes an inlet and an outlet defining an axis of the monolithic body.

Example 13: The method of example 12, further comprising heating a mixture of the PEEK and the carbon fibers above a melting temperature of the PEEK to form the thermoplastic mixture.

Example 14: The method of example 12 or 13, wherein the monolithic body defines a maximum length along the axis and a maximum diameter perpendicular to the axis, and wherein each of the maximum length and the maximum diameter are greater than or equal to about 25 centimeters.

Example 15: The method of any of examples 12 to 14, wherein the monolithic body is not rotationally symmetrical along the axis or reflectionally symmetrical across the axis.

Example 16: The method of any of examples 12 to 15, wherein the monolithic body comprises a pressure transition duct, and wherein the inlet and the outlet have different diameters.

Example 17: The method of any of examples 12 to 16, wherein the monolithic body comprises a substantially continuous microstructure.

Example 18: The method of any of examples 12 to 17, wherein the monolithic body comprises a polyether ether ketone (PEEK) matrix and carbon fibers distributed throughout the PEEK matrix, and wherein the carbon fibers are present in the PEEK matrix at a concentration of about 20 wt. % to about 40 wt. %.

Example 19: The method of any of examples 12 to 18, wherein the at least one pressurized component comprises a component of a vapor cycle refrigeration unit of the aircraft configured to operate at a temperature greater than or equal to about 80° C.

Example 20: The method of example 19, wherein the at least one pressurized component comprises a condenser, and wherein the monolithic body comprises an outlet plenum configured to couple to the condenser and discharge pressurized air from the condenser.

Various examples have been described. These and other examples are within the scope of the following claims.

What is claimed is:

1. A pressure containment component of a pressurized system of an aircraft, the pressure containment component comprising:
a dimensionally complex monolithic body including an inlet and an outlet defining an axis of the monolithic body, the monolithic body comprising:
a polyether ether ketone (PEEK) matrix; and
carbon fibers distributed throughout the PEEK matrix,
wherein the monolithic body is configured to contain a pressure greater than or equal to about 20 kPa from the pressurized system.

2. The pressure containment component of claim 1, wherein the monolithic body defines a maximum length along the axis and a maximum diameter perpendicular to the axis, and wherein each of the maximum length and the maximum diameter are greater than or equal to about 25 centimeters.

3. The pressure containment component of claim 1, wherein the monolithic body is not rotationally symmetrical along the axis or reflectionally symmetrical across the axis.

4. The pressure containment component of claim 1, wherein the monolithic body comprises a pressure transition duct, and wherein the inlet and the outlet have different diameters.

5. The pressure containment component of claim 1, wherein the monolithic body comprises a substantially continuous microstructure.

6. The pressure containment component of claim 1, wherein the carbon fibers are present in the PEEK matrix at a concentration of about 20 wt. % to about 40 wt. %.

7. The pressure containment component of claim 1, wherein the pressurized systems comprises a vapor cycle refrigeration unit of the aircraft.

8. The pressure containment component of claim 7, wherein the pressurized system includes a condenser, and wherein the monolithic body comprises an outlet plenum configured to couple to the condenser and discharge pressurized air from the condenser.

9. A system of an aircraft, the system comprising:
a vapor cycle refrigeration unit (VCRU) configured to cool pressurized bleed air from one or more engines of the aircraft using ram air, the VCRU comprising at least one pressurized component configured to operate at a pressure greater than or equal to about 20 kPa, the at least one pressurized component comprising a pressure containment component comprising:
a dimensionally complex monolithic body including an inlet and an outlet defining an axis of the monolithic body, the monolithic body comprising:
a polyether ether ketone (PEEK) matrix; and
carbon fibers distributed throughout the PEEK matrix.

10. The system of claim 9, wherein the at least one pressurized component is configured to operate at a temperature greater than or equal to about 80° C.

11. The system of claim 9, wherein the at least one pressurized component comprises a condenser, and wherein the monolithic body comprises an outlet plenum configured to couple to the condenser and discharge pressurized air from the condenser.

12. A method of forming a pressure containment component of a pressurized system of an aircraft, the method comprising:
injecting a thermoplastic mixture into a mold for a monolithic body of the pressure containment component, the thermoplastic mixture comprising:
molten polyether ether ketone (PEEK); and
carbon fibers in the molten PEEK; and
cooling the thermoplastic mixture to form the monolithic body of the component, wherein the monolithic body includes an inlet and an outlet defining an axis of the monolithic body.

13. The method of claim 12, further comprising heating a mixture of the PEEK and the carbon fibers above a melting temperature of the PEEK to form the thermoplastic mixture.

14. The method of claim 12, wherein the monolithic body defines a maximum length along the axis and a maximum diameter perpendicular to the axis, and wherein each of the maximum length and the maximum diameter are greater than or equal to about 25 centimeters.

15. The method of claim 12, wherein the monolithic body is not rotationally symmetrical along the axis or reflectionally symmetrical across the axis.

16. The method of claim 12, wherein the monolithic body comprises a pressure transition duct, and wherein the inlet and the outlet have different diameters.

17. The method of claim 12, wherein the monolithic body comprises a substantially continuous microstructure.

18. The method of claim 12, wherein the monolithic body comprises a polyether ether ketone (PEEK) matrix and carbon fibers distributed throughout the PEEK matrix, and wherein the carbon fibers are present in the PEEK matrix at a concentration of about 20 wt. % to about 40 wt. %.

19. The method of claim 12, wherein the at least one pressurized component comprises a component of a vapor cycle refrigeration unit of the aircraft configured to operate at a temperature greater than or equal to about 80° C.

20. The method of claim 19, wherein the at least one pressurized component comprises a condenser, and wherein the monolithic body comprises an outlet plenum configured to couple to the condenser and discharge pressurized air from the condenser.
